(19) United States
(12) Patent Application Publication
(10) Pub. No.: US 2011/0054684 A1
(43) Pub. Date: Mar. 3, 2011

(54) METHOD AND SYSTEM FOR TRANSFERRING/ACQUIRING OPERATION RIGHT OF MOVING ROBOT IN MULTI-OPERATOR MULTI-ROBOT ENVIRONMENT

(75) Inventors: Beom-Su SEO, Daejeon (KR); Sung-Hoon KIM, Daejeon (KR); Kyeong-Ho LEE, Daejeon (KR); Joong-Bae KIM, Daejeon (KR); Myung-Chan ROH, Daejeon (KR); Choul-Soo JANG, Daejeon (KR); Seung-Woog JUNG, Daejeon (KR); Seung-Ik LEE, Daejeon (KR); Yoon-Ju LEE, Daejeon (KR); Ji-Hung KIM, Daejeon (KR); Hyun-Chul PARK, Gyeonggi-do (KR); Joong-Ki PARK, Daejeon (KR)

(73) Assignees: ELECTRONICS AND TELECOMMUNICATIONS RESEARCH INSTITUTE, Daejeon (KR); SAMSUNG THALES CO., LTD., Gyeongbuk (KR)

(21) Appl. No.: 12/873,606

(22) Filed: Sep. 1, 2010

(30) Foreign Application Priority Data
Sep. 1, 2009 (KR) 10-2009-0081952

(51) Int. Cl. B25J 9/16

(52) U.S. Cl. 700/248; 901/50

(57) ABSTRACT

In an operating system having a first controller configured to manage one or more robots included in a first region, and a second controller configured to manage one or more robots included in a second region adjacent to the first region, a method for enabling the second controller to acquire an operation right of N robots (where N is a natural number equal to or greater than 1) operated by the first controller, the method includes: transmitting a control mapping status (CMS) containing an operation right change message to the first controller, upon reception of an operation right request signal from a user of the N robots; and checking a connection status of the N robots, upon reception of the CMS containing the operation right change message from the first controller, and acquiring an operation right by providing CMS acquisition information and control mapping information to the robots included in the second region.

### CROSS-REFERENCE(S) TO RELATED APPLICATIONS

The present invention claims priority of Korean Patent Application No. 10-2009-0081952, filed on Sep. 1, 2009, which is incorporated herein by reference in its entirety.

### BACKGROUND OF THE INVENTION

1. Field of the Invention

The present invention relates to a method and system for transferring/acquiring an operation right of a moving robot; and, more particularly, to a method and system for transferring/acquiring an operating right of a moving robot in a multi-operator multi-robot environment.

2. Description of Related Art

Early robots have been implemented with mechanical operations such as motors, and they are evolving into intelligent robots which have human being's learning ability. Robots may be classified into industrial robots and personal robots according to their purposes. Industrial robots may be used in manufacturing fields represented by factory automation such as welding, assembly, and so on, and non-manufacturing fields represented by field automation such as underwater works, medical services, and so on. Personal robots refer to robots used for housework, life support, leisure support, public welfare, and so on. Those robot technologies are developing toward a complex industry in which various fields such as a machinery industry for driving robots, an electronic industry such as sensors for detection and measurement, a communication industry for communication with other individuals, and a material industry for implementation of robots are combined together.

In the early robot operation technology, one controller connected to a cable controls one robot. With the advance of mobile robots, the robot operation technology is developing to enable a remote control through a wireless medium. Furthermore, technologies capable of controlling a plurality of robots through one controller have been developed.

FIG. 1 is a configuration diagram of a system in which one controller (remote operation station, hereinafter, referred to as an “ROS”) is provided for one robot.

Referring to FIG. 1, one ROS 120 is provided for controlling one robot 110. The ROS 120 may be connected to the robot 110 through a wired network such as a wired internet, or a wireless network such as a Wibro network.

FIG. 2 is a configuration diagram of a system for enabling a single operator to control a single robot and to assign a mission to the single robot in a single-operator single-robot access control (hereinafter, referred to as an “SSAC”) environment.

Referring to FIG. 2, an SSAC system is a system that requires n ROSs for n robots. A control domain 210 for controlling one robot exists in an SSAC environment. The SSAC environment includes a robot #1 211 configured to move under the control domain 210, and an ROS #1 212 configured to control the robot #1 211. The SSAC environment requires a plurality of ROSs so as to control a plurality of robots. Since the ROSs operate not organically but individually, there are limitations in accepting flexible system organizations according to purpose, operations and their hierarchical command control and symmetry according to mission structures.

FIG. 3 illustrates a hierarchical structure for enabling multi-operators to operate multi-robots in a multi-operator multi-robot access control environment.

Referring to FIG. 3, N robots and M ROSs configured to manage the N robots exist in an N-operator M-robot access control (hereinafter, referred to as an “NMAC”) environment. Also, an upper-level controller (remote mission station, hereinafter referred to as an “RMS”) configured to control the M ROSs is provided in the NMAC environment. The following detailed description will be made about an NMAC environment, on the assumption that that two ROSs configured to control N robots, and an RMS configured to control the two ROSs are provided in the NMAC environment. An RMS 310 checks operation information of ROSs 320 and 330 and status information of currently operating robots. The ROS 320 manages and operates a robot a1 341 to a robot aN 343, and the ROS 330 manages and operates a robot b1 351 to a robot 353. The operation and structure of the RMS and the ROSs will be described later in more detail with reference to FIGS. 5 and 6.

FIG. 4 is a configuration diagram of a system for enabling N operators to flexibly control and access M robots in an NMAC environment. In FIG. 4, a change from an SSAC environment to an NMAC environment is illustrated. Specifically, FIG. 4 illustrates a system architecture for enabling multi-operators to control multi-robots and assign missions to the multi-robots in order to overcome limitations set forth above in FIG. 1. In FIG. 4, a robot management domain may be divided into three types, that is, a mission domain 400, operation domains 420 and 460, and control domains 430 and 470. The mission domain 400 refers to a domain that controls an overall operation of the RMS 410 in a current NMAC environment. The operation domains 420 and 460 refer to a domain that has a capability of receiving an operation right from the RMS 410 and managing a robot on the basis of the operation right. The control domains 430 and 470 refer to a domain that controls a robot by using the actual ROSs 432 and 472. That is, robots that are not actually controllable but will be controllable may exist in the operation domains 420 and 460, and only robots that are actually controllable exist in the control domains 430 and 470. In other words, it means that the control domains 430 and 470 are a subset of the operation domains 420 and 460. The ROS #1 432 and the ROS #2 472 are in a state that holds a control right, and the robot #2 440, the robot #k 450, the robot #6 480, and the robot #j 490 are in a state that has an operation right but does not have a control right.

A system of an NMAC environment will be described below in more detail with reference to FIG. 4. The RMS 410 transmits an operation right plan to the ROS #1 432 and the ROS #2 472. The ROS #1 432 and the ROS #2 472 can control the operation right robot belonging to them by using the received operation right information. The RMS 410 has a flexible structure that may configure a system for an operating robot existing in other operation right by passing through an operation right transferring procedure with respect to the operation right robots operated by the ROS #1 432 and the ROS #2 472. The ROSs 432 and 472 enables the operator to give a remote traveling and mission assignment role to the control right robot through a setting of the control right. Remote control units (hereinafter, referred to as “RCUs”) 433 and 473 are portable remote control systems that may assign missions to the robots existing within the operation right. For example, the RCU 433 may assign a mission by setting an operation right of the robot #2. The RCU 433 may or may not be implemented in the system according to needs.

FIG. 5 is a configuration diagram of an ROS system operating in an NMAC environment.

Referring to FIG. 5, the ROS system includes an ROS processor 500 and a plurality of robots 511 to 513 controlled by the ROS processor 500. The ROS processor 500 includes a remote controller 521, an information processor 530, an image processor 540, a state processor 550, and a haptic processor 560. Specifically, the remote controller 521 controls the robots 511 to 513 through a wireless medium, and the information processor 530 receives information of the remote controller 521, or provides execution information to the remote controller 521. In addition, the image processor 540 displays a current status in a form of 2D/3D image, and the state processor 550 receives current information and changes a system mode to a mode appropriate to a current state. The haptic processor 560 has a wheel and a pedal and is a mechanism for actually operating the robots in remote. The remote controller 521 has a switch panel to select one of the robots, and acquires a control right of one robot by pressing a number switch assigned to the robot,

FIG. 6 is a configuration diagram of an RMS system based on two ROSs.

Referring to FIG. 6, the RMS system includes an image processor #1 610 and an information processor #1 620 configured to manage an ROS #1 630, an image processor #2 650 and an information processor #2 660 configured to manage an ROS #2 670, and a state monitor (a state processor) 640 configured to monitor a state in a 2D/3D manner. The ROS #1 630 transmits its own current image information and status information to the image processor #1 610 and the information processor #1 620, respectively. In addition, the ROS #2 670 transmits its own image information and status information to the image processor #2 650 and the information processor #2 660, respectively. The image information and the status information received from the ROSs 630 and 670 are analyzed by the image processors 610 and 650 and the information processors 620 and 660, transmitted to the state monitor (state processor) 640, and then controlled by the RMS operator.

In the SSAC environment as shown in FIG. 2, the system enables the single operator to control the single robot and assign a mission to the single robot. In the SSAC environment, there is no description on operation and synchronization of the multi-robots, which are required in an unmanned self-control system. Accordingly, the operator in remote area can operate only the single robot through real-time monitoring, remote traveling and self-control traveling. In the unmanned self-control system, which is a multi-operators to multi-robots operation basis system, the NMAC system must ensure multi-operators' flexible operability such as mission assignment with respect to the multi-robots. Therefore, there is a need for synchronization between an ROS processor and multi-robots in the NMAC system by changing operation rights of the multi-robots.

### SUMMARY OF THE INVENTION

An embodiment of the present invention is directed to providing a method and system for transferring/acquiring an operation right of a moving robot, capable of supporting a wider area.

Another embodiment of the present invention is directed to providing a method and system for transferring/acquiring an operation right of a moving robot, capable of increasing a mutual compatibility between systems.

Another embodiment of the present invention is directed to providing a method and system for transferring/acquiring an operation right of a moving robot, capable of flexibly modifying a system configuration.

In accordance with an aspect of the present invention, there is provided, in an operating system having a first controller configured to manage one or more robots included in a first region, and a second controller configured to manage one or more robots included in a second region adjacent to the first region, a method for enabling the second controller to acquire an operation right of N robots (where N is a natural number equal to or greater than 1) operated by the first controller, the method including: transmitting a control mapping status (CMS) containing an operation right change message to the first controller, upon reception of an operation right request signal from a user of the N robots; and checking a connection status of the N robots, upon reception of the CMS containing the operation right change message from the first controller, and acquiring an operation right by providing CMS acquisition information and control mapping information to the robots included in the second region.

In accordance with another aspect of the present invention, there is provided in an operating system having a first controller configured to manage one or more robots included in a first region, and a second controller configured to manage one or more robots included in a second region adjacent to the first region, a method for transferring an operation right of N robots (where N is a natural number equal to or greater than 1) operated by the first controller to the second controller, the method including: transmitting a latest control mapping status (CMS) message to the N robots, upon reception of an operation right change CMS connection from the second controller; and transmitting a CMS containing an operation right change message corresponding to the operation right change CMS connection received from the second controller.

In accordance with another aspect of the present invention, there is provided in an operating system having a first controller configured to manage one or more robots included in a first region, and a second controller configured to manage one or more robots included in a second region adjacent to the first region, a system for transferring an operation right of a first robot operated by the first controller to the second controller, the system including: a first control unit configured to transmit an operation right change control mapping status (CMS) connection to an upper-level controller when an operator requests an operation right change through the upper-level controller, the first controller or the second controller, and transmitting a CMS message when an operation right information share message is received from the upper-level controller; a second controller configured to transmit the operation right information share message to the upper-level controller when the operation right change CMS connection is received from the upper-level controller, and transmit the CMS message to the upper-level controller; and the upper-level controller configured to transmit the CMS containing operation right change message to the second controller when the CMS containing the operation right change message is received from the first controller, and transmit the operation right information share message to the first controller when the operation right information share message is received from the second controller.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a configuration diagram of a system in which one controller (remote operation station, “ROS”) is provided for one robot.

FIG. 2 is a configuration diagram of a system for enabling a single operator to control the single robot and to assign a mission to the single robot in a single-operator single-robot access control (SSAC) environment.

FIG. 3 illustrates a hierarchical structure for enabling N operators to operate M robots in an N-operator M-robot access control (NMAC) environment.

FIG. 4 is a configuration diagram of a system for enabling N operators to flexibly control and access M robots in an NMAC environment.

FIG. 5 is a configuration diagram of an ROS system operating in an NMAC environment.

FIG. 6 is a configuration diagram of an RMS system based on two ROSs.

FIG. 7 is a flowchart illustrating an operating procedure of a control right based on initial operation right plan information in order for synchronization between an ROS processor and multi-robots.

FIG. 8 is a flowchart illustrating a synchronization operation between multi-robots through an operation right change between an ROS 1 and an ROS 2 in accordance with an embodiment of the present invention.

FIGS. 9A and 9B are flowcharts illustrating an operation for synchronization between multi-robots through an operation right transfer among an ROS 1, an ROS 2, and an RMS, in case where an RMS is provided, in accordance with another embodiment of the present invention.

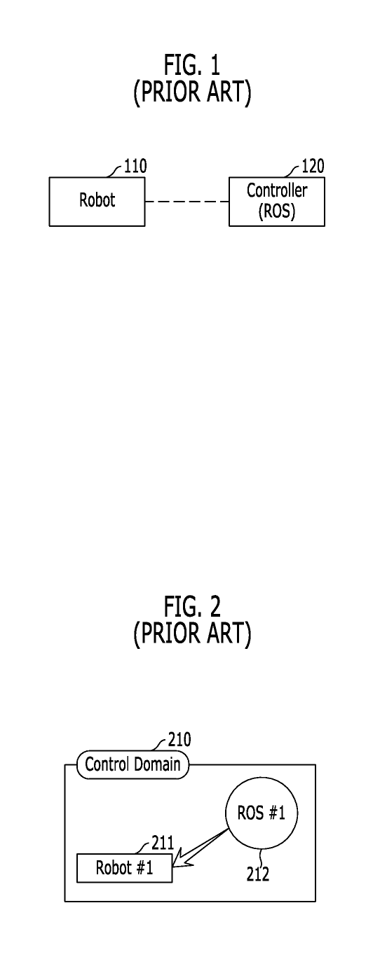

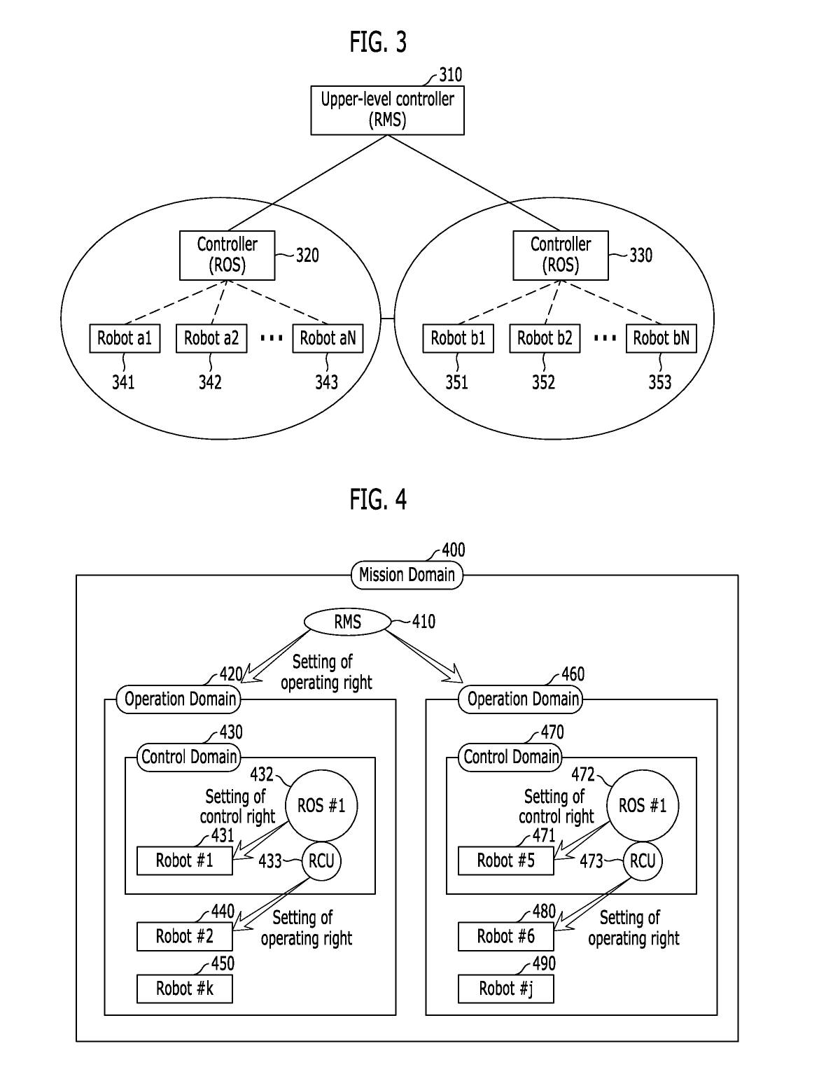

### DESCRIPTION OF SPECIFIC EMBODIMENTS

The advantages, features and aspects of the invention will become apparent from the following description of the embodiments with reference to the accompanying drawings, which is set forth hereinafter.

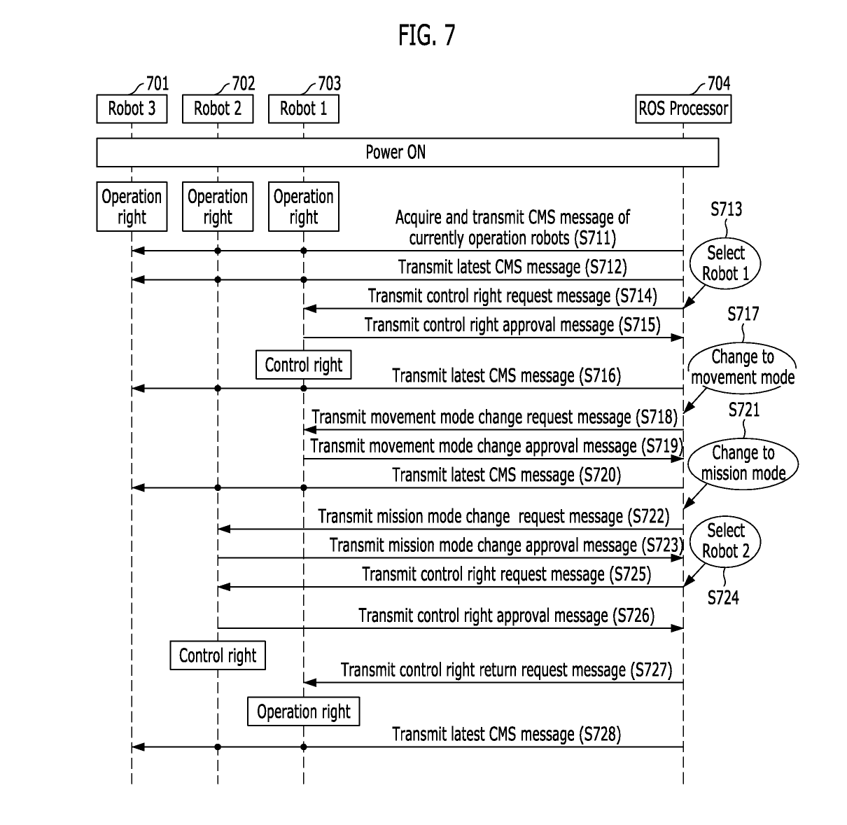

FIG. 7 is a flowchart illustrating an operating procedure of a control right based on initial operation right plan information in order for synchronization between an ROS processor and multi-robots.

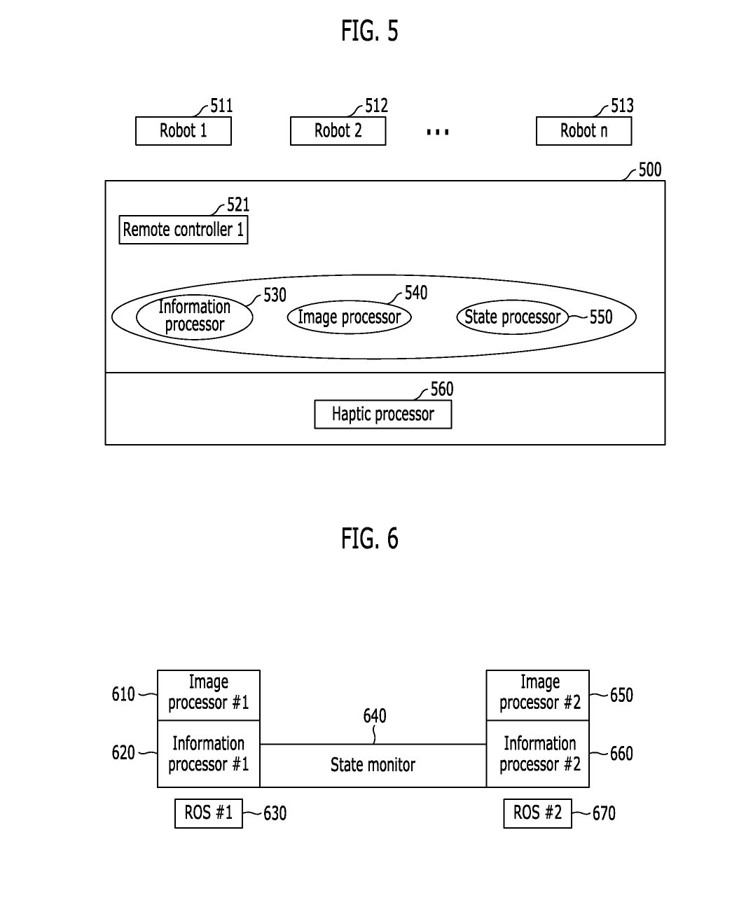

Like the ROS of FIG. 5, the ROS processor 704 of FIG. 7 includes a remote controller, an information processor, an image processor, a state processor and a haptic processor. The remote controller receives a signal from a robot and transmits information generated within the ROS processor 704 to the robot. The remote controller sets a control mapping status (hereinafter, referred to as a “CMS”) information connection to the image processor, the state processor and the haptic processor (which is referred to as “the processors inside the ROS”), and the processors inside the ROS sets a CMS information connection to the remote controller. The remote controller achieves an initial synchronization between the processors inside the ROS by transmitting initially planned CMS information to the processors inside the ROS. The CMS refers to information necessary to operate the robots, such as non-operation/operation information, operation right belonging information, control right belonging information, and movement and mission mode status information with respect to the multi-robots. The processors inside the ROS generate objects with respect to the multi-robots within the operation right, based on the CMS information, and establish a connection related to the operation information. The remote controller receives CMS acquisition information from the multi-robots within the operation right, and updates CMS message with respect to the robots that are in an operating state. Since the updated CMS message is transmitted to the processors inside the ROS and the multi-robots, the synchronization between the multi-robots and the processors inside the ROS is achieved. Through the above-described procedures in the normal operation environment, the operator performs a control right acquisition procedure with respect to the robots selected among the multi-robots within the operation right, and synchronizes the updated CMS message. Upon occurrence of an event of an operation change message, such as a movement mode change and a mission mode change of a control right robot, a movement and mission mode change of an operation right robot, and a request of a control right for an operation right robot from the RCU, the CMS message is also updated and thereafter the synchronization between the systems is achieved by sharing the CMS message with the multi-robots and the processors inside the ROS.

The control and operation between the ROS processor 704 and the currently operating robots 701 to 703 will be described below with reference to FIG. 7. The robot 1 703, the robot 2 702, and the robot 3 701 are in an operation right state, but not in a control right state. At step S711, if the ROS processor 704 and the robots 701 to 703 are powered on, the ROS processor 704 acquires CMS message of the currently operating robots and transmits the acquired CMS message to the robot 1 703, the robot 2 702, and the robot 3 701. At step S712, the ROS processor 704 transmits the updated latest CMS message to the robot 1 703, the robot 2 702, and the robot 3 701. The latest CMS message is used to transmit the latest operation information before or after performing an operation such an operation right or a control right.

Steps S713 to S715 are procedures of acquiring a control right in order for the ROS processor 704 to control the robot 1 703 that is in an operation right state. At the step S713, the ROS processor 704 selects the robot 1 703. The step S713 may be performed by turning on the remote controller of the ROS processor 704 that manages the robot 1 703. At the step S714, the ROS processor 704 transmits a control right request message to the robot 1 703 selected at the step S713. At the step S715, the robot 1 703 transmits a control right approval message in response to the control right request message of the step S714. If the steps S713 to S715 are completed, the robot 1 703 changes from the operation right state to the control right state. At step S716, the ROS processor 704 transmits the latest CMS message to the robot 1 703.

Steps S717 to S723 are procedures of changing the robot mode. Specifically, the steps S717 to S720 are procedures of changing the robot being in a control right state to a movement mode, and the steps S721 to S723 are procedures of changing the robot being in an operation right state to a mission mode. At the step S717, the ROS processor 704 determines to change the mode of the robot 1 703 to the movement mode. At the step S718, a movement mode change request message is transmitted to the robot 1 703 that is in a control right state. At the step S719, the robot 1 703 transmits a movement mode change approval message to the ROS processor 704 in response to the movement mode change request message received at the step S718. At the step S720, the ROS processor 704 transmits the latest CMS message to the robot 1 703. At the step S721, the ROS processor 704 determines to change the robot 2 702 being in an operation right state to a mission mode. At the step S722, a mission mode change request message is transmitted to the robot 2 702. At the step S723, the robot 2 702 transmits a mission mode change approval message to the ROS processor 704 in response to the mission mode change request message of the step S722.

Steps S724 to S726 are procedures of changing the robot 2 702 being in an operation right state to a control right state. The steps S724 to S726 are substantially identical to the described-above steps S713 to S715. When the step S726 is completed, the robot 2 702 changes to a control right state. At step S727, the ROS processor 704 returns the control right by transmitting a control right return request message to the robot 1 703 in order to change the robot from the control right state to an operation right state. When the step S727 is completed, the robot 1 703 changes from the control right state to the operation right state. At step S728, the ROS processor 704 transmits the latest CMS message to the robot 2 702.

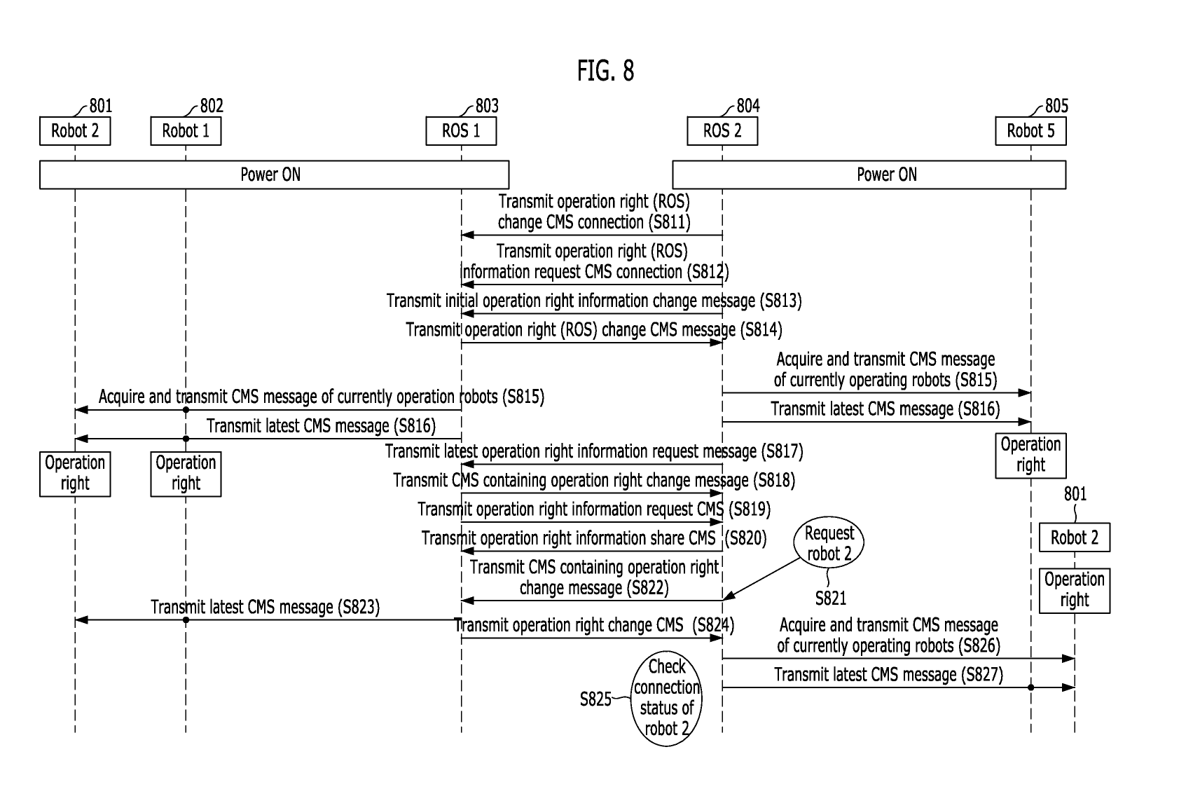

FIG. 8 is a flowchart illustrating a synchronization procedure between multi-robots through an operation right change between an ROS 1 and an ROS 2 in accordance with an embodiment of the present invention.

Referring to FIG. 8, two ROSs 803 and 804 are provided. Two robots, that is, a robot 1 802 and a robot 2 801 belong to the ROS 1 803, and a robot 5 805 belongs to the ROS 2 804. In the following description, it is assumed that the ROS 1 803 operates as a master and the ROS 2 804 operates as a slave. Unlike the environment of FIG. 7 in which the ROS processor 704 operates solely, the CMS message is synchronized through an operation right change in two ROS systems. To this end, the remote controller of the ROS 2 804 confirms existence/nonexistence of the RMS through a network connection state. When the RMS does not exist, an object of the remote controller of the ROS 1 803 is generated, and an operation right change message and an operation right information request connection are established. In the respective ROS systems, the synchronization is achieved by sharing the CMS message provided in FIG. 7. The remote controller of the ROS 804 transmits the initial CMS message to the remote controller of the ROS 1 803 by using the operation right change message between the ROSs. The remote controllers of the ROSs 803 and 804 update the operation right change message to the CMS message and transmits the updated CMS message to the processors inside the ROS and the operating multi-robots. The operators of the ROS 1 803 and the ROS 2 804 may request robot operation information to each other, and the synchronization may be achieved by sharing the CMS message of the opposite side whenever the received CMS message or the operation information is generated. The operators may confirm the operation status of the multi-robots operated in the ROS systems. The operator of the ROS 2 804 may configure the system by transmitting the operation right change message to the multi-robots operated in the ROS 1 803. The processors inside the respective ROSs and the multi-robots are synchronized by sharing the changed CMS message between the remote controllers of the ROS 1 803 and the ROS 2 804.

The operation right change between the ROSs will be described below with reference to FIG. 8. Steps S811 to S814 are procedures of setting a connection for sharing operation right information each other and acquiring initial operation right information. At the step S811, the ROS 2 804 transmits the operation right change CMS connection to the ROS 1 803 in order to set a connection for transmitting the operation right change CMS. At the step S812, the ROS 2 804 transmits the operation right information request CMS connection to the ROS 803. At the step S813, the ROS 2 804 transmits the initially planned operation right information change message to the ROS 1 803. At the step S814, the ROS 1 803 transmits the CMS containing the operation right change message to the ROS 2 804. In this manner, the connection for transmitting the initial operation right information is set and the initial operation right information is acquired.

At step S815, the ROSs 803 and 804 acquire and transmit the currently operating CMS message to the robots that are in an operation right state. At step S816, the latest CMS message is transmitted to the robots.

Steps S817 to S827 are procedures of transferring the operation right when the robot 2 801 moves from the ROS 1 803 to the ROS 2 804. At the step S817, the ROS 2 804 transmits the latest operation right information request message. At the step S818, the ROS 1 803 transmits the CMS containing operation right change message to the ROS 2 804. At the step S819, the ROS 1 804 transmits the operation right information request CMS to the ROS 1 803. At the step S820, the ROS 2 804 transmits the operation right information share change CMS to the ROS 1 803 in response to the step S819. At the steps S821 and S822, when the user requests the use of the robot 2 801, the newly entered ROS, that is, the ROS 2 804 transmits the CMS containing the operation right change message to the existing ROS, that is, the ROS 1 803. At the step S823, the ROS 1 803 transmits the latest CMS message to the robot 2 801. At the step S824, the ROS 1 803 transmits the operation right change CMS to the ROS 2 804 in response to the step S822. At the step S825, the ROS 2 804 checks the connection status of the robot 2 801. At the step S826, the ROS 2 804 acquires the CMS message of the currently operating robot and transmits the acquired CMS message to the robot 2 801. At the step S827, the ROS 2 804 transmits the latest CMS message. The ROS may be expanded to two or more according to expansion and necessity of the network.

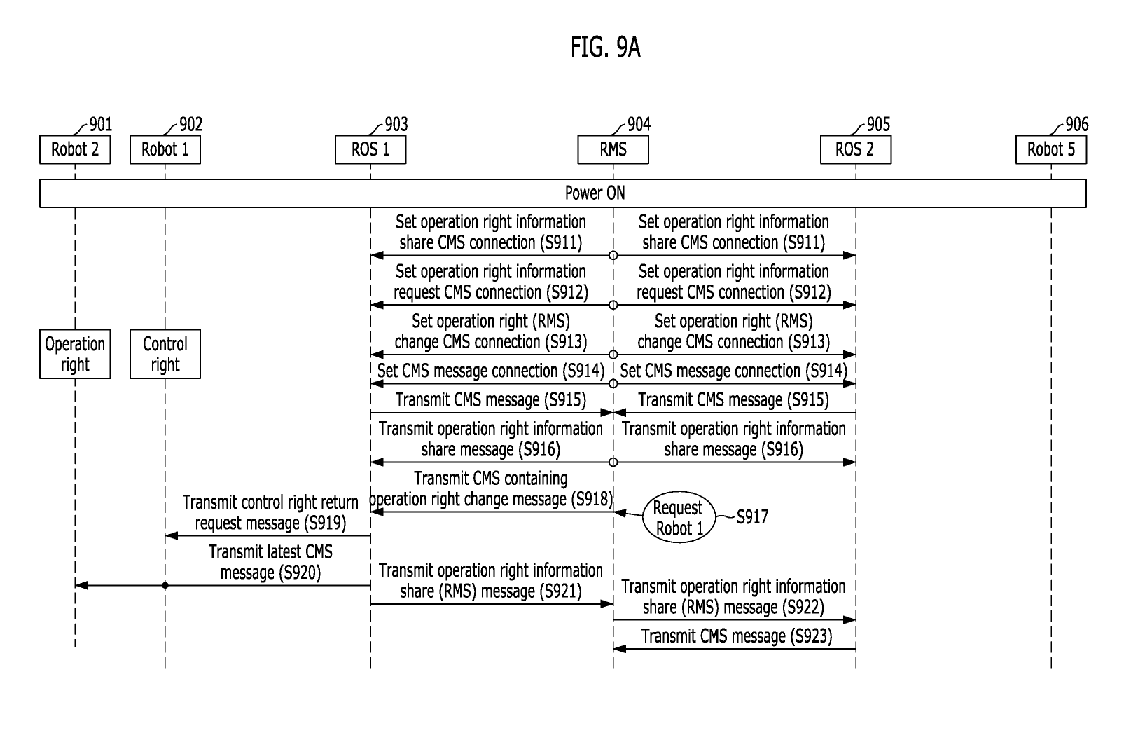

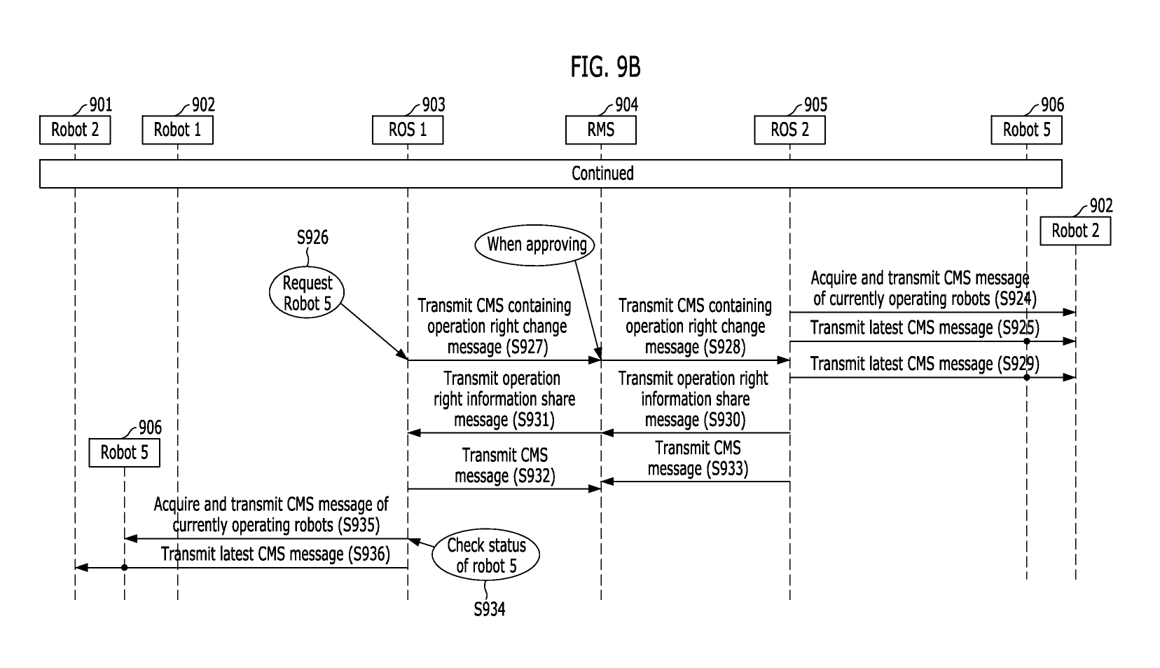

FIGS. 9A and 9B are flowcharts illustrating an operation for synchronization between multi-robots through an operation right transfer among an ROS 1, an ROS 2, and an RMS, in case where an RMS is provided, in accordance with another embodiment of the present invention.

Unlike the operation environment of FIG. 8, since an RMS system is provided, the operator can configure the system more flexibly and operate according to a mission structure. A state processor of an RMS 904 connects operation right information related methods to remote controllers of ROSs 903 and 905. The remote controllers of the ROSs 903 and 905 transmit initial CMS message to the state processor of the RMS 904. The state processor of the RMS 904 updates CMS message collected at the ROS 1 903 and the ROS 2 905, and transmits the updated CMS message through an operation right change CMS. The remote controllers of the ROSs 903 and 905 transmit the updated CMS message to the processors inside the ROS and the initially planned multi-robots. In this way, the initial synchronization is achieved. The operator of the RMS 904 may confirm the operation information state with respect to the multi-robots operated at the ROS 1 903 and the ROS 2 904, and may configure the system for the multi-robots operated within the ROSs 903 and 905 through the operation right transfer. The operators of the ROSs 903 and 905 may also configure the system for multi-robots existing in other operation right.

A synchronization procedure of the ROS 1 903, the ROS 2 905, and the RMS 904 when the robot moves will be described below with reference to FIG. 9. Steps S911 to S914 are procedures of setting a connection for interlocking the ROS 1 903 and the ROS 2 905, centering on the RMS 904. At the step S911, the RMS 904 sets an operation right information share CMS connection to the ROS 1 903 and the ROS 2 905. At the step S912, the RMS 904 sets an operation right information request CMS connection to the ROS 1 903 and the ROS 2 905. At the step S913, the RMS 904 sets an operation right change CMS connection to the ROS 1 903 and the ROS 2 905. At the step S914, the RMS 904 sets a CMS message connection to the ROS 1 903 and the ROS 2 905. At step S915, the ROS 1 903 and the ROS 2 905 transmit current CMS message to the RMS 904. At step S916, the RMS 904 transmits operation right information share message to the ROS 1 903 and the ROS 2 905 in order to share the operation right, based on the CMS message received at the step S915.

Steps S917 to S927 are operation procedures in case where the robot 1 902 moves from the ROS 1 domain to the ROS 2 domain. In the following description, it is assumed that the robot 1 902 is in a control right state. At the steps S917 and S918, when a new operator (an operator of the ROS 2 905 in FIG. 9) requests an operation right of the robot 1 902, the RMS 904 transmits the CMS containing the operation right change message to the ROS 1 903. At the step S919, since the robot 1 902 is in a control right state, the ROS 1 903 transmits a control right return request message to the robot 1 902 in order to cancel the control right. At the step S920, the ROS 1 903 transmits the latest CMS information to the robot 1 902. At the step S921, the ROS 1 903 transmits an operation right information share message to the RMS 904. At the step S922, the RMS 904 transmits the operation right information share message received from the ROS 1 903 to the ROS 2 905. At the step S923, the ROS 2 905 transmits its own CMS information to the RMS 904. At the step S924, the ROS 2 905 confirms the status of the robot 1 902, acquires the CMS information of the currently operating robot, and transmits the acquired CMS information to the robot 1 902. At the step S925, the ROS 2 905 transmits the latest CMS message to the robot 1 902.

Steps S928 to S940 are procedures of a case where the robot 5 906 moves from the ROS 2 domain to the ROS 1 domain. This case is substantially similar to the above-described case of the robot 1 902, where a new operator (an operator of the ROS 1 903 in FIG. 9) requests a robot operation right. Since the robot 5 906 is currently in an operation right state, a process of canceling a control right is unnecessary, and the other processes are identical to the processes of the step S917 to S927. Through the above-described processes, the ROS 1 903, the ROS 2 905, the RMS 904, and the multi-robots may be synchronized. The multi-robots within the operation right may be flexibly controlled by continuously updating a CMS config file through the operation right procedure and sharing the CMS information. The RMS and the ROS may be expanded to two or more according to expansion and necessity of the network.

In accordance with the embodiments of the present invention, the method and system for transferring/acquiring the operation right of the moving robot can support a wider area, increase a mutual compatibility between systems, and easily modify a system configuration.

While the present invention has been described with respect to the specific embodiments, it will be apparent to those skilled in the art that various changes and modifications may be made without departing from the spirit and scope of the invention as defined in the following claims.

What is claimed is:

1. In an operating system having a first controller configured to manage one or more robots included in a first region, and a second controller configured to manage one or more robots included in a second region adjacent to the first region, a method for enabling the second controller to acquire an operation right of N robots (where N is a natural number equal to or greater than 1) operated by the first controller, the method comprising:
transmitting a control mapping status (CMS) containing an operation right change message to the first controller, upon reception of an operation right request signal from a user of the N robots; and
checking a connection status of the N robots, upon reception of the CMS containing the operation right change message from the first controller, and acquiring an operation right by providing CMS acquisition information and control mapping information to the robots included in the second region.

2. The method of claim 1, further comprising;
before transmitting the CMS containing the operation right change message, setting a channel for exchanging the operation right information between the first controller and the second controller.

3. The method of claim 2, further comprising:
after completing the setting of the connection and before transmitting the CMS containing operation right change message, transmitting information for sharing the operation right information of the robots, which are operated at the respective controllers, with the first controller and the second controller.

4. The method of claim 1, wherein the control mapping status includes non-operation/operation information, operation right belonging information, control right belonging information, and movement and mission mode status information, which are necessary to operate the robots.

5. In an operating system having a first controller configured to manage one or more robots included in a first region, and a second controller configured to manage one or more robots included in a second region adjacent to the first region, a method for transferring an operation right of N robots (where N is a natural number equal to or greater than 1) operated by the first controller to the second controller, the method comprising:
transmitting a latest control mapping status (CMS) message to the N robots, upon reception of an operation right change CMS connection from the second controller; and
transmitting a CMS containing an operation right change message corresponding to the operation right change CMS connection received from the second controller.

6. The method of claim 5, further comprising;
before transmitting the latest CMS message, setting a channel for exchanging the operation right information between the first controller and the second controller.

7. The method of claim 6, further comprising:
after completing the setting of the connection and before transmitting the latest CMS message, transmitting information for sharing the operation right information of the robots, which are operated at the respective controllers, with the first controller and the second controller.

8. The method of claim 5, wherein the CMS message includes non-operation/operation information, operation right belonging information, control right belonging information, and movement and mission mode status information, which are necessary to operate the robots.

9. In an operating system having a first controller configured to manage one or more robots included in a first region, and a second controller configured to manage one or more robots included in a second region adjacent to the first region, a system for transferring an operation right of a first robot operated by the first controller to the second controller, the system comprising:
the first controller configured to transmit an operation right change control mapping status (CMS) connection to an upper-level controller when an operator requests an operation right change through the upper-level controller, the first controller or the second controller, and transmitting a CMS message when an operation right information share message is received from the upper-level controller;
the second controller configured to transmit the operation right information share message to the upper-level controller when the operation right change CMS connection is received from the upper-level controller, and transmit the CMS message to the upper-level controller; and
the upper-level controller configured to transmit the CMS containing operation right change message to the second controller when the CMS containing the operation right change message is received from the first controller, and transmit the operation right information share message to the first controller when the operation right information share message is received from the second controller.

10. The system of claim 9, wherein the operator requests the upper-level controller to set a connection for sharing operation right information between the first controller and the second controller before the operator requests to the operation right change.
